(19) United States
(12) Patent Application Publication
(10) Pub. No.: US 2008/0175159 A1
(43) Pub. Date: Jul. 24, 2008

(54) High Performance Three-Port Switch for Managed Ethernet Systems

(75) Inventors: Jack E. Caveney, Hinsdale, IL (US); Ronald A. Nordin, Naperville, IL (US)

Correspondence Address: PANDUIT CORP., LEGAL DEPARTMENT - TP12, 17301 SOUTH RIDGELAND AVENUE, TINLEY PARK, IL, 60477, US

(73) Assignee: PANDUIT CORP., Tinley Park, IL (US)

(21) Appl. No.: 11/954,489

(22) Filed: Dec. 12, 2007

Related U.S. Application Data
(60) Provisional application No. 60/869,806, filed on Dec. 13, 2006.

(51) Int. Cl. G06F 11/00

(52) U.S. Cl. 370/248

(57) ABSTRACT

A method and apparatus for isolating and analyzing segments of a deployed, operational cable plant from a remote location. Individual cables, or segments, within an operationally deployed cable plant infrastructure may be isolated and analyzed without requiring a technician to physically inspect and perform an on-site analysis. The approach allows a cable segment to be isolated and analyzed without physically disconnecting the cable from the deployed infrastructure. By isolating and analyzing selected cable plant segments, an entire deployed cable plant infrastructure may be discretely analyzed and specific problems within the cable plant infrastructure may be identified. The approach allows the analyses to be performed from a remote location and is compatible with and may be integrated within a multipurpose network management system.

### BACKGROUND

1. Technical Field

This invention pertains to network cable infrastructure maintenance. In particular, the present invention pertains to apparatus and techniques for isolating and analyzing operationally deployed segments of a network cable plant infrastructure.

2. Description of Related Art

One of the difficult challenges faced by Information Technology (IT) infrastructure network managers is determining how to diagnose with specificity network faults that are related to faults in a deployed cable plant infrastructure.

Faults associated with relatively short cables, such as patch panel cords used within network equipment closets, are often related to damaged or improperly installed cable terminators and/or internal cable shorts due to an inadvertent pinching or crushing of the cable. Poor connections can also be caused by damaged sockets in patch panels and/or network equipment. Unfortunately, faults associated with longer cable runs, typically associated with the horizontal (or distribution) cable plants, may be even more problematic. Although cables may perform adequately when first installed, over time, numerous faults may arise. For example, network connections supported by individual cables may begin to experience difficulties due to corrosion, or due to small nicks/cracks in the conductors (introduced during the installation process and/or introduced during subsequent maintenance) that develop into larger cracks or breaks in conductors. Further, shorts between wires may arise due to damage to conductors or damage to conductor insulation internal to a cable's protective casing. Such damage is typically caused by the stress of pulling a cable through conduits and tight locations, chafing of cable casings, melting of wire casings due to wires having been inadvertently placed near hot surfaces such as overhead lighting, damage due to rodents chewing cable casings, and a litany of other potential sources of physical damage. In addition, interference may be introduced to one or more cables in a cable segment by sources of electromagnetic radiation such as electric motors, electrical boxes, etc.

Typically, when a network manager suspects that a network problem involves contributions from a faulty network cable, the network manager will instruct a technician to physically locate and inspect the cable or cables in question. Unfortunately, such physical inspections take significant time on the part of the technician as the technician attempts to locate both ends of a cable, disconnect the cable from the network, attach test equipment, and proceed to analyze the cable. Further, such a test does not adequately test the connections between the cable and the cable plant jacks to which the cable connects. In addition, the process of disturbing a cable may result in the introduction of new problems which may have otherwise been avoided. The above process is more complicated in large IT networks involving cable plants within multiple physically distributed locations or remote locations.

Hence, a need remains for a method and apparatus for diagnosing segments of the deployed cable plant infrastructure, without requiring a technician to physically inspect cable plants and perform on-site analysis. Preferably, such an approach would allow a cable segment to be isolated and analyzed without physically disconnecting the cable from the deployed infrastructure. Further, such an approach would preferably be performed quickly and easily from a remote location. Preferably, the approach should be compatible with and capable of being integrated with a multipurpose network management system.

### SUMMARY OF THE INVENTION

A method and apparatus are provided for isolating and analyzing segments of a deployed, operational cable plant from a remote location. Individual cables, or segments, within an operationally deployed cable plant infrastructure may be isolated and analyzed without requiring a technician to physically inspect and perform an on-site analysis. The approach allows a cable segment to be isolated and analyzed without physically disconnecting the cable from the deployed infrastructure. By isolating and analyzing selected cable plant segments, an entire deployed cable plant infrastructure may be discretely analyzed and specific problems within the cable plant infrastructure may be identified. The approach allows the analyses to be performed quickly and easily from a remote location. Further, the approach is compatible with and may be integrated within a multipurpose network management system.

A method is described for detecting faults present in a deployed network cabling infrastructure that includes isolating an identified cable segment from the network cabling infrastructure, executing diagnostics upon the isolated cable segment, and determining whether a fault exists in the isolated cable segment based upon a result of the executed diagnostics. The identified cable segment is isolated by physically redirecting a connectivity of the identified cable based upon a command issued from a remote network management system.

An apparatus is described for detecting faults present in a deployed network cabling infrastructure that includes an isolation module that isolates an identified cable segment from the network cabling infrastructure, a diagnostics module that executes diagnostics upon the isolated cable segment, and an analysis module that determines whether a fault exists in the isolated cable segment based upon a result of the executed diagnostics. The isolation module physically isolates the identified cable segment by redirecting connectivity of the identified cable segment based upon a command issued from a remote network management system.

A process capable of being implemented by program instructions executable by a computer is described for detecting faults present in a deployed network cabling infrastructure that includes an isolation module that isolates an identified cable segment from the network cabling infrastructure, a diagnostics module that executes diagnostics upon the isolated cable segment, and an analysis module that determines whether a fault exists in the isolated cable segment based upon a result of the executed diagnostics. The isolation module physically isolates the identified cable segment by redirecting connectivity of the identified cable segment based upon a command issued from a remote network management system.

The systems and methods of the present invention may be used to provide a network management system with information on Ethernet connections, such as information on connections between Ethernet switch ports and patch panel ports. The network management system may later use the systems and methods of the present invention to verify those connections.

### BRIEF DESCRIPTION OF THE DRAWINGS

Exemplary embodiments according to the present invention are described below with reference to the above drawings, in which like reference numerals designate like components.

FIG. 1 is a block diagram of a first exemplary patch panel capable of isolating and supporting the analysis of a cable deployed within an operational cable plant.

FIG. 2 is a block diagram of a second exemplary patch panel capable of isolating and supporting the analysis of a cable deployed within an operational cable plant.

FIG. 3 is a block diagram of an exemplary three port switch for use within a patch panel or other controlled device to isolate and support the analysis of a cable deployed within an operational cable plant.

FIGS. 4A and 4B are cross-sectional views of a first exemplary micro-electronic mechanical system (MEMS) switch which may be used within the three port switch depicted in FIG. 3.

FIGS. 5A and 5B are cross-sectional views of a second exemplary MEMS switch which may be used within the three port switch depicted in FIG. 3.

FIG. 6 is an exemplary flow chart of the workflow associated with isolating and analyzing a cable deployed within an operational cable plant.

### DETAILED DESCRIPTION OF PREFERRED EMBODIMENTS

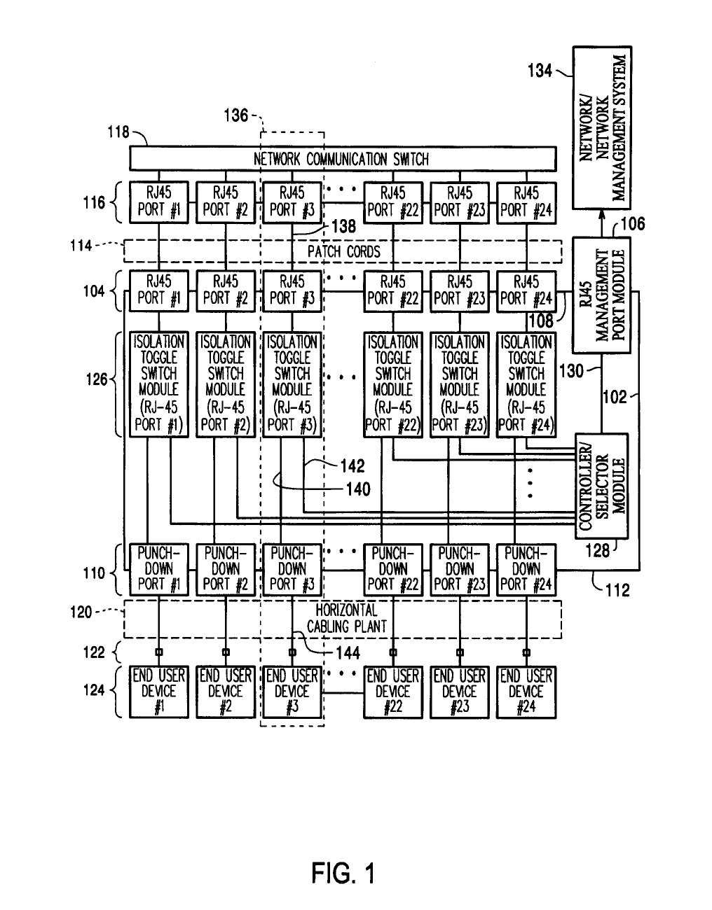

FIG. 1 is a system-level block diagram of an exemplary patch panel 102 capable of isolating and supporting the analysis of a cable deployed within an operational cable plant. As shown in FIG. 1, patch panel 102 may include a front patch panel face 108 that may include a plurality of RJ-45 patch panel ports 104 and an RJ-45 management port 106. Patch panel 102 may further include a rear patch panel face 112 that may include a plurality of punch-down ports 110. As shown in FIG. 1, each of the plurality of RJ-45 ports 104 on front patch panel face 108 may connect to one of a plurality of ports 116 on a network communication switch 118 via one of a plurality of patch cords 114. As further shown in FIG. 1, each of the plurality of punch-down ports 110 may connect via one of a plurality of cables in horizontal cabling plant 120 to an end-user device jack 122. Each end-user device jack 122 shown in FIG. 1 may support a connection from an end-user network device 124 to a network via network communication switch 118.

The above description of patch panel 102 is exemplary only. The location and arrangement of specific ports on patch panel 102 may be changed as desired for easy access/use. For example, management port 106 may be placed upon rear patch panel face 112 rather than front patch panel face 108. Further, patch panel 102 is not limited to being configured with RJ-45 and punch down block connections. Patch panel 102 may be configured to support any type of network cable connection, including optical cabling as well cabling with electrical conductors.

As depicted in FIG. 1, the patch panel 102 is used to provide connectivity between end-user devices 124 and a network communication switch 118. However, patch panel 102 may also be used to facilitate connectivity between network devices. For example, an IT infrastructure may incorporate numerous patch panels 102 within a deployed network cable plant in order to facilitate connectivity between networked devices and/or to facilitate connectivity between segments of the deployed network cable plant. For example, each end of a bundle of horizontal cables spanning a distance between two equipment rooms may be terminated in a patch panel 102. Additional patch panels 102 may be used within each equipment room to facilitate establishing connectivity with other cable segments and/or equipment within the equipment room.

Referring again to FIG. 1, an end-user device 124 may connect to a port 116 on communication switch 118 via a connection that includes patch panel 102. For example, with respect to connection 136, connectivity between network communication switch 118 and patch panel 102 passes from switch port #3, through patch cord 138 to RJ-45 port #3. Connectivity between patch panel 102 and end-user device 124 passes from punch-down port #3 through horizontal cable 144, to wall jack 122 and finally to end-user device #3.

Within patch panel 102, connectivity from RJ-45 port #3 to punch-down port #3 passes from RJ-45 port #3 to an isolation toggle switch module 126 for RJ-45 port #3 and through connection 140 to punch-down port #3. However, if isolation toggle switch #3 is activated, connectivity is redirected from toggle switch module 126 through connection 142 to controller/selector module 128.

In normal operation, connectivity within patch panel 102 between punch-down port 110 and RJ-45 port 104 is a straight pass-through connection. However, in response to a control signal from controller/selector module 128, isolation toggle switch 126 may disconnect connectivity between RJ-45 port 104 and punch-down port 110 and redirect the connection from RJ-45 port 104 to RJ-45 management port 106 on the front face panel of patch panel 102. By disconnecting connectivity internal to patch panel 102 the connectivity across patch cord 114 between RJ-45 port 104 and communication switch port 116 is effectively isolated from the deployed cable plant infrastructure and the isolated patch cord connection is made accessible to a network management system 134 for analysis.

As shown in FIG. 1, controller/selector module 128 is connected to RJ-45 management port 106 and to the external network/network management system 134 via connection 130. Through such a connection, the external network management system 134 may selectivity instruct controller/selector module 128 to isolate and make available for analysis any of the plurality of patch cords 114. Such an approach allows any of the individual patch cords 114 to be selectively isolated from the deployed network cable plant without physically disturbing the physical patch cord connections. In this manner, any of the individual patch cords 114 may be analyzed from a single remote network management system 134, without requiring a technician to travel to the physical cable plant location, without requiring the technician to physically locate a cable in question, and without requiring the disruption of a deployed cable from its connections within the deployed infrastructure. Further, such an approach allows each patch cord to be selectively isolated and analyzed to determine which port in the patch panel is connected to which port of the Ethernet switch.

In another embodiment, multiple patch panels can be provided between the network communication switch 118 and the end-user devices 124. For example, a patch panel (not shown) may be provided between the switch 118 and the patch panel 102 or between the patch panel 102 and the end-user devices 124. The patch panel (not shown) may be configured similarly to patch panel 102. Alternatively, the patch panel (not shown) may be configured differently. For example, the patch panel (not shown) may be disposed between the switch 118 and the patch panel 102 and may be configured such that the isolation toggle switches isolate the punch-down ports while the isolation toggle switches 126 in the patch panel 102 isolate the RJ45 ports 104. Such an arrangement permits isolation of one of the patch cords connecting the patch panel with the patch panel 102 with or without including the patch cords 138 between the switch 118 and the patch panel. This permits determination of which patch cord, connecting the switch 118 with the patch panel or connecting the patch panel with the patch panel 102, is faulty. Alternatively, the patch panels may isolate the patch cords between the patch panel most proximate to the switch 118 and the switch 118 and the patch cords between the patch panel most proximate to the end-user devices 124 and the end-user devices 124, leaving the patch cords between the patch panels untested. In this case, if a fault exists in the patch cords between the patch panels, it can be tested indirectly by determining that a fault lies between the switch 118 and the end-user devices 124 and also determining that no fault lies between the patch cords between the patch panel most proximate to the switch 118 and the switch 118 and the patch cords between the patch panel most proximate to the end-user devices 124 and the end-user devices 124.

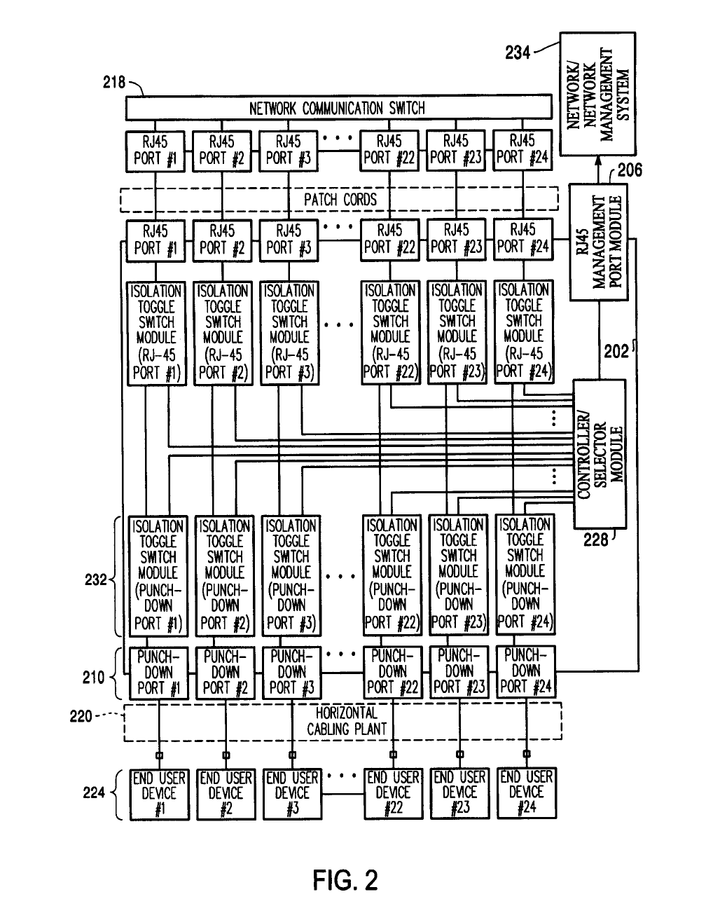

FIG. 2 is a system-level block diagram of a second exemplary patch panel 202 that is capable of isolating a segment of a deployed operational cable plant for analysis by network management system 234. As shown in FIG. 2, patch panel 202 is very similar to patch panel 102 (FIG. 1); however, patch panel 202 includes an additional set of isolation toggle switches 232. Each of isolation toggle switches 232 may be used to redirect connectivity from a punch-down port 210 via controller/selector module 228 to an RJ-45 network management port 206 for analysis by network management system 234, as described above.

Deployed within a network infrastructure as shown in FIG. 2, patch panel 202 may selectively isolate and analyze any of the physical cable connections between the patch panel and communication switch 218. Further, patch panel 202 may selectively isolate and analyze any of the physical cable connections between patch panel 202 and the end-user devices 224. The network configurations presented FIG. 1 and FIG. 2 are exemplary only. Patch panel 202 may be placed anywhere within any network configuration. For example, patch panel 202 may be used to facilitate connectivity between network devices. A deployed network cable plant may incorporate numerous patch panels 202 in order to facilitate connectivity between network devices and/or to facilitate connectivity between segments of the deployed network cable plant infrastructure. For example, each end of a bundle of horizontal cables spanning a distance between two equipment rooms may be terminated in a patch panel 202. Additional patch panels 202 may be used within each equipment room to facilitate connectivity with other cable segments and/or equipment within the equipment room. For example, the configuration depicted in FIG. 2 may be used to selectively isolate and analyze individual cables within horizontal cable plant 220 to identify or verify the end-user device that is attached to each respective cable.

Depending upon the number and location of patch panels 202 deployed within a network infrastructure, a network management system may isolate and analyze virtually any portion of the network cable plant located between patch panel 202 and a network device, any portion of a network cable plant located between patch panel 202 and an end-user device, and any portion of the network cable plant (e.g., cables in a bundle between equipment rooms) located between any two patch panels 202. Such portions may comprise any portion of the cable plant.

In analyzing a portion of the network cable plant between patch panel 202 and a network device, network management system 234 may run a series of diagnostic routines that communicate with the network device. For example, in the case of a network communication switch that supports internal self diagnostics, network management system 234 may execute the switch diagnostics and verify that the expected results are received at the patch panel 202 management port 206. Such a set of diagnostic routines may fully test the cable plant connection between the switch and patch panel 202 and, if successful, may allow the diagnostics process to proceed with the isolation and analysis of other segments within the deployed cable infrastructure.

Similarly, in analyzing a portion of the network cable plant between patch panel 202 and an end-user device, network management system 234 may run a series of diagnostic routines that communicate with the end-user device and verify that expected results are received via a patch panel management port 206. For example, diagnostic routines may be pre-loaded onto a workstation and may be activated by network management system 234 to test connectivity between the end-user workstation and patch panel 202.

Further, to analyze a portion of the network cable plant between two patch panels 202, network management system 234 may instruct the controller/selector modules to initiate a set of diagnostic signals over the isolated cable (i.e., controller/selector module to controller/selector module) to verify the integrity of the connection. Once completed, the respective controller/selector modules may return a message to network management system 234 via management port 206 that may include the results of the test routines. Such a set of diagnostic routines may fully test the selected cable between the respective patch panels 202.

Within such an exemplary embodiment, network management system 234 may isolate an individual cable within an operationally deployed cable plant infrastructure to determine (e.g., via communication between the network management system and the port) an identifier of a specific switch and an identifier of a specific switch port to which the cable is connected. Such an approach may be used by network management system 234 to discover port level connectivity information that may be stored by the network management system for later use. Once such connectivity information is stored, the network management system may later verify the previously detected information and/or discover configuration changes in the network cabling infrastructure by comparing the previously detected information with subsequently detected information.

For example, a network management system may use such an approach to monitor/verify the proper execution of network cable plant move/add/change instructions implemented by a technician in accordance with a work order. By comparing a detected change in network connectivity with a planned change described in the work order, the network management system may determine whether a work order has been properly implemented and/or may assist a technician in properly implementing the work order. Although this approach has been described with reference to patch panel 202, the approach also may be used with patch panel 102 or any combination thereof.

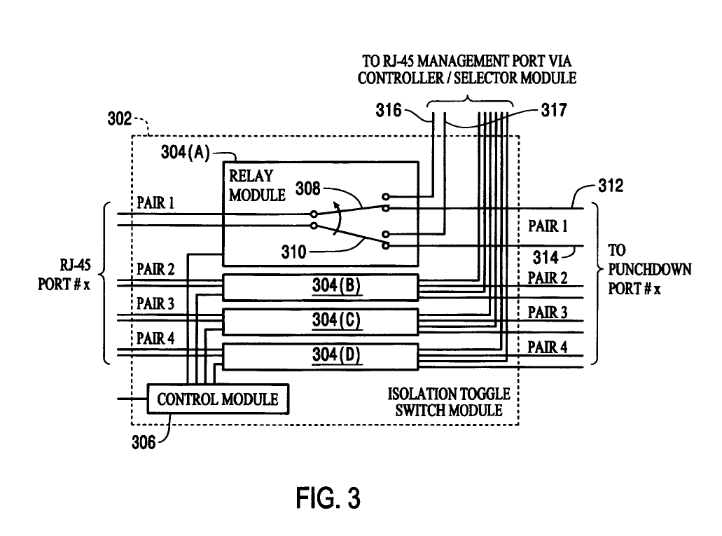

FIG. 3 is a block diagram of an isolation toggle switch module 302 that may be used within a patch panel or other controlled device to isolate and support the analysis of a cable deployed within an operational cable plant. As shown in FIG. 3, isolation toggle switch module 302 may include a plurality of relay modules 304(a-d), each of which is capable of redirecting the connectivity of a single RJ-45 pair of connectors. For example, four such relay modules (e.g., 304a-304d) may be used to redirect each of the four pairs of connectors within an RJ-45 based connection. In FIG. 3, relay modules 304(a-d) are used to redirect connectivity between an RJ-45 port and its respective punch-down port to an RJ-45 management port connected to a remote network management system, as described above with respect to FIGS. 1 and 2.

As shown in FIG. 3 with respect to relay module 304a, in response to a signal from control module 306 relay module 304a may redirect wires 308 and 310 of pair 1 from a state of contact with wires 312 and 314 associated with pair-1 of a punch-down port to a state of contact with wires 316 and 317 associated with pair-1 of an RJ-45 management port. Relay modules 304b through 304d operate in a similar manner as relay module 304a, thus allowing all four pairs of wires associated with the RJ-45 port to be redirected to the RJ-45 management port. Further, upon instruction from control module 306, relay modules 304a-304d may reestablish connectivity between the RJ-45 port and the punch-down port. In one exemplary embodiment, connectivity between the RJ-45 port and the punch-down port is the default that is established when no power is applied to relay modules 304a-304d. Thus, in one embodiment the default configuration, unless altered by a signal from control module 306, is to establish a pass-through connection between the RJ-45 port and the punch down port. Although control module 306 is shown as a part of isolation toggle switch module 302, it may be in the patch panel but separate from the isolation toggle switch module 302, as shown in FIGS. 1 and 2.

Use of isolation toggle switch 302 is not limited to redirecting connections within a patch panel device. For example, an isolation toggle switch 302 may be integrated within a wall jack or other controlled device to allow a remote network management system to selectively redirect and/or disconnect connectivity at the wall jack in support of network diagnostics and/or trouble-shooting efforts. For example, by disconnecting cable connectivity at a selected wall jack, a network management system could run diagnostics between a patch panel, as described above, and a wall jack to assess the integrity of the horizontal cable between the patch panel and the wall jack. If the horizontal cabling is found to be operational, the network management system may reestablish connectivity at the wall jack and may proceed to execute additional diagnostics to analyze full connection between the patch panel and an end-user device connected to the network via the wall jack, as described above.

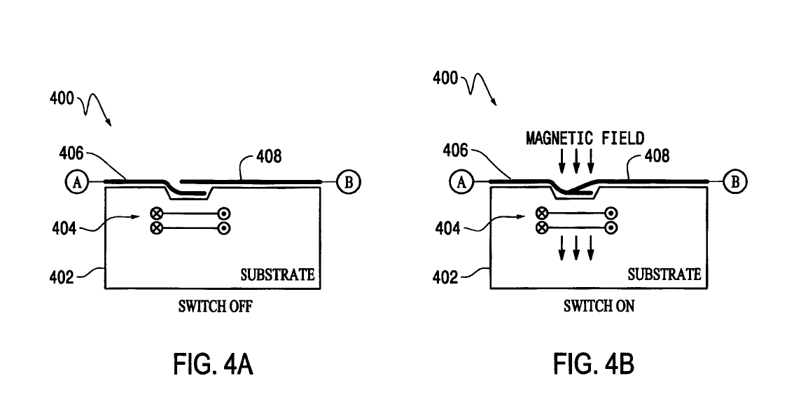

FIGS. 4a and 4b are cross-sectional views of a first embodiment of a micro electronic mechanical system (MEMS) switch, or relay, which may be used within an embodiment of the isolation toggle switch depicted within FIG. 3. As shown in FIG. 4a, MEMS switch 400 may include a substrate 402 (e.g. silicon) with an embedded coil 404 that may be used to apply a magnetic field to overlapping metallic plates 406 and 408 positioned proximate to the coil 404. As shown in FIG. 4b, upon application of a current through coil 404, a magnetic field is established that draws magnetic conductor 408 against magnetic conductor 406 thus establishing an electrical connection between ports A and B.

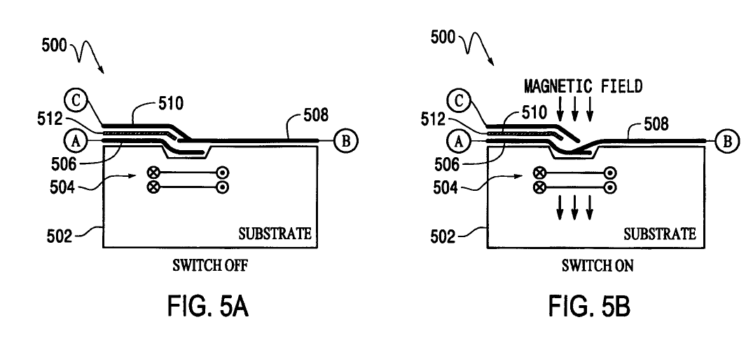

FIGS. 5a and 5b are cross-sectional views of a second MEMS switch, or relay, which may be used within an embodiment of the isolation toggle switch 302 depicted within FIG. 3. MEMS switch 500 is very similar to MEMS switch 400 (FIG. 4). As shown, MEMS switch 500 may include a substrate 502 (e.g. silicon) with an embedded coil 504 that may be used to apply a magnetic field to overlapping magnetic plates 506 and 508 positioned approximate to the coil 504. As further shown in FIG. 5a, a third metal plate 510 is positioned above magnetic plate 506, and separated from magnetic plate 506 by an insulating layer 512.

When no current is passed through coil 504, metal plates 508 and 510 rest in physical contact with one another, thus forming a connection between nodes A and C. However, as shown in FIG. 5b, upon application of a current through coil 504 a magnetic field is established that draws magnetic conductor 508 against magnetic conductor 506 thus establishing an electrical connection between ports A and B. In this manner, a connection between nodes A and C is redirected to establish a connection between nodes A and B upon selectively applying power to coil 504.

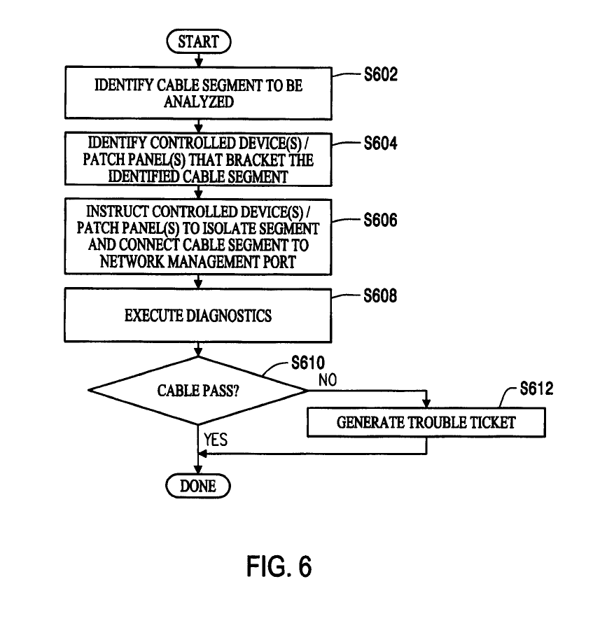

FIG. 6 is a procedural flow chart that summarizes an exemplary workflow associated with isolating and performing analysis of a segment of a deployed cable plant infrastructure, as described above. As shown in FIG. 6, at step S602, a network manager or Network Management System identifies a cable segment to be analyzed. The network manager or Network Management System next identifies, at step S604, the controlled device(s) and/or patch panel(s) that bracket the identified cable segment. Next, at step S606, the network manager, or Network Management System, instructs the identified controlled device(s) and/or patch panel(s) to isolate the identified cable segment and to connect the isolated cable segment to a network management port. Then, at step S608, the network manager or Network Management System initiates or executes one or more diagnostic routines to analyze and verify the isolated cable and/or to analyze a network or end-user device to which the isolated cable is connected. If the Network Management System determines, at step S610, that the cable segment has passed, i.e., has been confirmed to have no faults, the testing process is complete, otherwise, the Network Management System may generate a report, or trouble ticket, that indicates the nature of the problem(s) detected, as shown at S612.

For example, a Network Management System may receive a status report, e.g., a Simple Network Management Protocol (SNMP) trap message, from one or more controlled network devices that indicates a communication failure and/or a failure of Power-over-Ethernet (PoE) service at a network device/port identified in each of the respective one or more trap messages. In response, the Network Management System may identify controlled network device(s) and/or patch panel(s) that bracket a cable segment experiencing difficulty. Controlled network devices may be identified based upon, for example, an analysis of previously collected and maintained network connectivity information stored in the Network Management System's information base. Next, the Network Management System may instruct the one or more of the identified controlled device(s) and/or patch panel(s) to isolate the identified cable segment by connecting one or more connection ends of the identified cable segment to a network management port. Once the Network Management System has network connectivity to the isolated cable, at one or both ends of the isolated cable segment, the Network Management System may initiate or execute one or more diagnostic routines (e.g., such as a Time Domain Reflectometry, or TDR, routine) to analyze the isolated cable. Further, the Network Management System may request, e.g., via SNMP, configuration and status parameters associated with the controlled device connected to the isolated cable to assist in further trouble-shooting the problem.

For example, if the TDR routine is executed and returns a weak return reflection, Network Management System may determine that communication along the isolated cable segment is adversely affected by a kink in the isolated cable. If the TDR routine receives a strong return reflection, the Network Management System may determine that communication has been broken or cut. Further, the TDR routine may determine a distance of the kink or break in the cable from an isolated cable end based upon the time delay and magnitude of the received reflected signals. The results of any diagnostic routines executed by the Network Management System upon an isolated cable may be stored within the Network Management System's information base for later review and/or analysis.

For example, individual results from the testing of individual cable segments may be stored and later viewed collectively to assess the cumulative, or net, effect of, for example, distortion and impedance of the individual cable segments upon a selected source-to-destination physical cable path within the network that includes multiple cable segments. Further, stored results for one or more cable segments, collected over a period of time, may be later viewed collectively to assess a rate of change over time in the one or more cable segments with respect to distortion or impedance. Such a cumulative analysis may be used to optimize cable maintenance/replacement planning by helping to identify cable segment replacements that would result in acceptable end-to-end physical cable plant performance and/or by identifying cable segments likely to require replacement in the near future.

Upon determining that the isolated cable segment is damaged, the Network Management System may take measures to correct the identified problem. For example, the Network Management System may redirect a connection over another cable that physically connects the network devices affected by the failed cable. This redirection can be intermittent or constant, e.g., in the former case if the connection is shared temporally (i.e. in use by different end-user devices at different times) or in the latter case if one or more unused backup connections are present between the patch panel and the network switch. The isolation switch may be, in other embodiments, a tri-state switch or have more than three connection possibilities to enable the redirection. For example, in the default configuration, an RJ-45 port and corresponding punch-down port are connected together; in a test configuration, the RJ-45 port and/or corresponding punch-down port are connected to the NMS via the controller/selector module and management port, and in a bypass configuration; a different RJ-45 port and the same punch-down port are connected together. Alternatively, one or more cross-connect switches can be disposed in the patch panel along the signal path between the RJ-45 ports and the punch-down ports to permit different RJ-45 ports and punch-down ports to be connected in the event of a cable problem. In another embodiment, in which isolation switches are disposed both between the controller/selector module and the RJ-45 port and between the controller/selector module and the punch-down port (similar to FIG. 2), in the bypass configuration, a different RJ-45 port and the same punch-down port may be connected together via the controller/selector module. Such arrangements permit either preset or arbitrary connections between the RJ-45 and punch-down ports. Alternatively, the Network Management System may generate a fault message to a network manager's report log, or generate a trouble ticket within a Maintenance Management System to initiate corrective action by management personnel.

It will be appreciated that the exemplary embodiments described above and illustrated in the drawings represent only a few of the many ways of isolating and analyzing operational segments of a deployed network cable plant infrastructure. The present invention is not limited to analysis of the specific IT network cable infrastructure configurations disclosed herein, but may be applied to any deployed IT network infrastructure.

The network cable plant segment isolation and analysis process may be implemented in any number of modules and is not limited to any specific software module architecture. Each module can be implemented in any number of ways and is not limited in implementation to execute process flows precisely as described above. The network cable plant segment isolation and analysis processes described above and illustrated in the flow charts and diagrams may be modified in any manner that accomplishes the functions described herein.

It is to be understood that various functions of the network cable plant segment isolation and analysis methods and apparatus may be distributed in any manner among any quantity (e.g., one or more) of hardware and/or software modules or units, computer or processing systems or circuitry.

A patch panel that supports the cable plant segment isolation and analysis process may support patching of any type of network cabling, including but not limited to copper and/or optical fiber cabling. Patch panel ports on the face plate of a patch panel and/or patch panel network management ports may support any type of cable and cable connector, including but not limited to RJ-45 based connectors and optical fiber connectors. Patch panel ports on the rear plate of a patch panel may support any type of cable and cable connector, including but not limited to punch-down ports, RJ-45 ports, optical fiber connections, etc. The patch panel may also have circuitry other than that shown.

A controlled device, such as a wall jack, that supports the cable plant segment isolation and analysis process may support physical connections of any type of network cabling, including but not limited to copper and/or optical fiber cabling. Ports on a front face plate of a controlled device, such as a wall jack, may support any type of cable and cable connector, including but not limited to RJ-45 based connectors and optical fiber connectors. Ports on a rear plate of a controlled device may support any type of cable and cable connector, including but not limited to punch-down ports, RJ-45 ports, optical fiber connections, etc.

An isolation toggle switch module that supports the cable plant segment isolation and analysis process may support the redirection of any type of network cabling, including but not limited to copper and/or optical fiber cabling. Although an exemplary isolation toggle switch module may be configured to redirect cable conductors associated with an RJ-45 connector, such an embodiment is exemplary only and should not be interpreted as limiting an isolation toggle switch module to redirecting RJ-45 based conductors exclusively.

A relay module that supports the cable plant segment isolation and analysis process may support the redirection of any type of network cabling, including but not limited to copper and/or optical fiber cabling. Although an exemplary relay module may be configured to redirect cable conductors associated with an RJ-45 connector, such an embodiment is exemplary only and should not be interpreted as limiting a relay module to redirecting RJ-45 based conductors exclusively.

A relay, such as a MEMS switch, that supports the cable plant segment isolation and analysis process may support the redirection of any type of network cabling, including but not limited to copper and/or optical fiber cabling. Although an exemplary MEMS switch based embodiment of the relay may be configured to redirect cable conductors associated with an RJ-45 connector, such an embodiment is exemplary only and should not be interpreted as limiting a relay to redirecting RJ-45 based conductors exclusively.

Network Management System processes associated with the cable plant segment isolation and analysis processes may be integrated within a stand-alone system or may execute separately and be coupled to any number of devices, workstation computers, server computers or data storage devices via any communication medium (e.g., network, modem, direct connection, etc.). The Network Management System processes associated with the cable plant segment isolation and analysis process can be implemented by any quantity of devices and/or any quantity of personal or other type of computers or processing systems (e.g., IBM-compatible, Apple, Macintosh, laptop, palm pilot, microprocessor, etc.). The computer system may include any commercially available operating system (e.g., Windows, OS/2, Unix, Linux, DOS, etc.), any commercially available and/or custom software (e.g., communication software, load-averaged smoothing process software, etc.) and any types of input devices (e.g., keyboard, mouse, probes, I/O port, etc.).

It is to be understood that the Network Management System software associated with the cable plant segment isolation and analysis process may be implemented in any desired computer language, and could be developed by one of ordinary skill in the computer and/or programming arts based on the functional description contained herein and the flow charts illustrated in the drawings. For example, in one exemplary embodiment the cable plant segment isolation and analysis process may be written using the C+ programming language, however, the present invention is not limited to being implemented in any specific programming language. The various modules and data sets may be stored in any quantity or types of file, data or database structures. Moreover, the software associated with the cable plant segment isolation and analysis process may be distributed via any suitable medium (e.g., stored on devices such as CD-ROM and diskette, downloaded from the Internet or other network (e.g., via packets and/or carrier signals), downloaded from a bulletin board (e.g., via carrier signals), or other conventional distribution mechanisms).

The format and structure of internal structures used to hold intermediate information in support of the cable plant segment isolation and analysis process can include any and all structures and fields and are not limited to files, arrays, matrices, status and control booleans/variables.

The cable plant segment isolation and analysis process software may be installed and executed on a computer system in any conventional or other manner (e.g., an install program, copying files, entering an execute command, etc.). The functions associated with the cable plant segment isolation and analysis process may be performed on any quantity of computers or other processing systems. Further, the specific functions may be assigned to one or more of the computer systems in any desired fashion.

The cable plant segment isolation and analysis process may accommodate any quantity and any type of data set files and/or databases or other structures containing stored data sets, measured data sets and/or residual data sets in any desired format (e.g., ASCII, plain text, any word processor or other application format, etc.).

Cable plant segment isolation and analysis process output may be presented to the user in any manner using numeric and/or visual presentation formats. Cable plant analysis output may be presented as input to a numerical analysis tool in either numeric or visual form and can be processed by the numerical analysis tool in any manner and/or using any number of threshold values and/or rule sets.

Further, any references herein of software performing various functions generally refer to computer systems or processors performing those functions under software control. The computer system may alternatively be implemented by hardware or other processing circuitry. The various functions of the cable plant segment isolation and analysis process may be distributed in any manner among any quantity (e.g., one or more) of hardware and/or software modules or units, computer or processing systems or circuitry, where the computer or processing systems may be disposed locally or remotely of each other and communicate via any suitable communication medium (e.g., LAN, WAN, Intranet, Internet, hardwire, modem connection, wireless, etc.). The software and/or processes described above and illustrated in the flow charts and diagrams may be modified in any manner that accomplishes the functions described herein.

From the foregoing description it will be appreciated that a novel cable plant segment isolation and analysis system and method are disclosed that are capable of accurately assessing a deployed cable plant infrastructure based upon a segment-by-segment analysis of the respective isolatable segments within the deployed cable plant infrastructure.

Note that the above patch panel descriptions are exemplary only. The location and arrangement of specific ports on a patch panel may be changed in any manner desired for easy access/use. For example, a management port may be placed anywhere upon any accessible face of the patch panel. Further, the management port, or any other port supported by the patch panel, is not limited to being configured as an RJ-45 or punch down block connection. Patch panel ports may be configured to support any type of network cable connection, including optical cabling as well as cabling with electrical conductors.

While a cable plant segment isolation and analysis system is disclosed, any modifications, variations and changes within the skill of one of ordinary skill in the art fall within the scope of the present invention. Although specific terms are employed herein, they are used in their ordinary and accustomed manner only, unless expressly defined differently herein, and not for purposes of limitation.

What is claimed is:

1. A communication system comprising:
a first network device including a first and second port;
a second network device including a third port;
a first cable connecting the third port with the first port; and
a second cable connected to the second port,
an isolation switch configured to isolate the first and second cables from each other;
a control module configured to control the isolation switch such that the isolation switch establishes connectivity between at least:
the first port and the second port, or
the control module and the first port or the second port; and
a network manager configured to manage the control module.

2. The communication system of claim 1, wherein the first network device further comprises a management port through which the network manager communicates with the control module.

3. The communication system of claim 1, wherein the isolation switch comprises first and second isolation switches, the first isolation switch connected to the second port through the second isolation switch and the second isolation switch connected to the first port through the first isolation switch.

4. The communication system of claim 1, wherein the first and second ports are disposed on opposite faces of the first network device.

5. The communication system of claim 1, wherein the first network device comprises the control module and the isolation switch.

6. The communication system of claim 1, wherein the network manager is configured to run a diagnostic routine that tests connectivity through the first port or the second port when the isolation switch establishes the connection between the controller and the first port or the second port.

7. The communication system of claim 6, wherein the network manager is configured to store port level connectivity information and compare previously detected port level connectivity information with subsequently detected port level connectivity information.

8. The communication system of claim 6, wherein:
the first network device contains a plurality of first ports and a plurality of second ports; and
when the network manager detects a connectivity problem through one of the first ports or one of the second ports, the network manager is configured to redirect communication through a different first port or second port respectively.

9. The communication system of claim 1, wherein the isolation switch comprises a relay module which is capable of redirecting the connectivity of a single pair of wire connectors connected thereto.

10. The communication system of claim 1, wherein the isolation switch has a default configuration in which connectivity is established between the first port and the second port when no power is applied to the isolation switch.

11. The communication system of claim 1, wherein the isolation switch comprises a micro electronic mechanical system (MEMS) switch that includes a substrate and overlapping first and second conductive plates, the first and second conductive plates in electrical contact with each other when the MEMS switch is actuated and isolated from each other when the MEMS switch is not actuated.

12. The communication system of claim 11, wherein the MEMS switch further comprises:
a third conductive plate; and
an insulating layer disposed between the first and third conductive plates, the first and third conductive plates in electrical contact with each other when the MEMS switch is not actuated and isolated from each other when the MEMS switch is actuated.

13. The communication system of claim 1, wherein the second network device comprises a wall-plate jack.

14. The communication system of claim 1, wherein the first network device comprises a patch panel that is connected with at least one of a patch panel or a network communication switch via the second port.

15. A network device comprising:
first and second sets of ports;
isolation switches; and
a control module configured to control the isolation switches such that at least one isolation switch establishes connectivity between at least:
one of the first set of ports and one of the second set of ports in a default configuration of the isolation switch, or
the control module and one of the first set of ports or one of the second set of ports while isolating the one of the first set of ports from the one of the second set of ports.

16. The network device of claim 15, further comprising a management port through which the control module is able to communicate with a network manager.

17. The network device of claim 15, wherein the isolation switches comprise first and second isolation switches, the first isolation switches connected to the second set of ports through the second isolation switches and the second isolation switches connected to the first set of ports through the first isolation switches.

18. The network device of claim 15, wherein the first and second sets of ports are disposed on opposite faces of the network device.

19. The network device of claim 15, wherein each isolation switch comprises a relay module which is capable of redirecting the connectivity of a single pair of connectors connected thereto.

20. The network device of claim 15, wherein the network device comprises a switch, a patch panel, a jack, or a wall-plate jack.

21. A patch panel comprising:
a first and second set of ports disposed on oppose faces of the patch panel;
isolation switches;
a control module configured to control the isolation switches such that at least one isolation switch establishes connectivity between at least:
one of the first set of ports and one of the second set of ports in a default configuration of the isolation switch, or
the control module and one of the first set of ports or one of the second set of ports while isolating the one of the first set of ports from the one of the second set of ports in a test; and
a management port through which the control module is able to communicate with a network manager.

22. The patch panel of claim 21, wherein the first set of ports comprises RJ45 ports and the second set of ports comprises punch-down ports.

23. The patch panel of claim 21, wherein the isolation switches comprise first and second isolation switches, the first isolation switches connected to the second set of ports through the second isolation switches and the second isolation switches connected to the first set of ports through the first isolation switches.

24. The patch panel of claim 21, wherein in a bypass configuration, connectivity is established between a different one of the first set of ports and the one of the second set of ports or between the one of the first set of ports and a different one of the second set of ports.
